(19) United States
(12) Patent Application Publication
(10) Pub. No.: US 2018/0047052 A1
(43) Pub. Date: Feb. 15, 2018

(54) SYSTEMS AND METHODS FOR DELIVERING RELEVANT CONTENT AND ADVERTISEMENTS

(71) Applicant: SOCIAL NETWORKING TECHNOLOGY, INC., Wichita, KS (US)

(72) Inventors: Kevin OWENS, Wichita, KS (US); Taewook KANG, Wichita, KS (US); William Klausmeyer, Wichita, KS (US)

(21) Appl. No.: 15/672,551

(22) Filed: Aug. 9, 2017

Related U.S. Application Data
(60) Provisional application No. 62/372,821, filed on Aug. 10, 2016.

(51) Int. Cl. G06Q 30/02; H04L 29/08; G06F 17/30

(52) U.S. Cl. CPC G06Q 30/0251; G06F 17/30867; H04L 67/22

(57) ABSTRACT

Systems and methods for delivering relevant content and/or advertisements are provided. Information about the content of one or more web pages of a particular website is collected so that keywords for particular categories of web pages can be identified. The keywords can then be matched to a set of data to produce one or more lists of information relevant to the particular categories of the particular website. When a user visits a web page that falls within a particular category of a particular website, the lists presented to the user in his/her browser relates to the other content on the web page.

### BACKGROUND OF THE INVENTION

Exemplary embodiments of the present invention are directed to systems and methods for selecting and delivering relevant content and advertisements, for selecting and delivering relevant content, and for selecting and delivering relevant advertisements.

Internet webpages are reproduced by web browsers using code known as HyperText Markup Language (HTML). Initial versions of HTML were limited in the type of content that could be reproduced by a web browser, typically limited to text and images. Over time HTML developed to allow more complex content reproduction using, for example, extensions to the original HTML specification, including Cascading Style Sheets (CSS). This development allowed, among other things, the use of plug-ins that can execute non-HTML code, such as Java, Flash, and the like. This not only provided richer content but also provided the ability to display interactive content, such as providing an interactive video game.

This richer content can be achieved using web widgets, which are small software applications with limited functionality that can be installed and executed within a web page by an end-user. Web widgets look and act like traditional applications but are implemented using web coding technologies, such as JavaScript, Flash, HTML, and/or CSS. Thus, web widgets can either execute browser-native code, such as HTML and/or CSS, or plug-in code, such as JavaScript, Flash, etc.

In many instances web widgets reproduced on web pages are nothing more than advertisements, such as multiple-choice polls, which direct the user to another web site to view the results of the poll. These advertisement web widgets, as well as web widgets in general and advertisements in general, typically have little relevance to the underlying content of the web page. For example, many advertisements are selected for display on web pages using cookies stored on a user's computer and the product/service being advertised is one the user viewed on another website, such as a shopping website. Thus, a user may see the same advertisement for a stereo when viewing an article on CNN.com for a sports story as when viewing a political story on Politico.com because the user previously viewed a stereo on a shopping website.

In contrast to web widgets displaying advertisements, which may be relevant to the user due to the user's browsing history, non-advertisement web widgets are typically static in the sense that the web widget is assigned to a particular web page or set of web pages and displayed each time the web page or pages are displayed. Examples of these include page counters and event countdown clocks (e.g., the number of shopping days left until Christmas).

### SUMMARY OF THE INVENTION

Although displaying advertisements based on a user's browsing history might provide advertisements relevant to the user, these advertisements are not particularly relevant to the content of the web page the user is currently viewing, which raises a number of problems. This can be unsettling and confusing to a user because the advertisement may be displayed on a completely different website from which the user's browsing history was collected to select the advertisement. The user thus has an unsettling feeling that his/her Internet activities are being tracked and monitored. Further, in many instances a user viewed a particular product on a shopping website but ultimately chose not to purchase the item for any number of reasons, and thus displaying the product again to the user may not be productive because the user is not interested in the product. It is also problematic for advertisers because the advertisement can be displayed along with content the advertiser does not approve of or is not comfortable with having its products/services being displayed alongside.

Current static non-advertisement web widgets also suffer from a number of problems. First, these web widgets are often arbitrary and not particularly related to the underlying content on the web page. Further, the content of these web widgets do not change over time (or only change after long periods of time) and thus a user may see the same non-advertisement web widget many times and quickly lose interest in the content of the non-advertisement web widget.

Accordingly, exemplary embodiments of the present invention are directed to systems and methods for delivering content and/or advertisements that are relevant to the other content on a web page. This is achieved by collecting information about the content of one or more web pages of a particular website so that keywords for particular categories of web pages can be identified. The keywords can then be matched to a set of data to produce one or more lists of information relevant to the particular categories of the particular website. Accordingly, when a user visits a web page that falls within a particular category of a particular website, the lists presented to the user in his/her browser relates to the other content on the web page.

According to one embodiment a method according to the invention comprises a computer obtaining a configuration file for a selected website having a plurality of web pages and selecting a web page from the plurality of web pages. The computer identifies links to at least two additional web pages on the selected web page and analyzes content of the at least two additional web pages to identify one or more keywords. The computer then sorts the one or more keywords based on frequency of use on the at least two additional web pages and matches the one or more keywords with target words. One or more sorting criteria are identified based on the match of the one or more keywords with the target words. A plurality of lists is generated based on the one or more keywords and the one or more sorting criteria and computer code is generated for a web browser to display a container including a list content area and an advertisement content area. The generated code is provided to the web browser, wherein the list content area displays information for one of the plurality of lists and the advertisement content area displays an advertisement related to the one of the plurality of lists.

According to another embodiment a method involves a web browser being executed on a processor receiving code corresponding to a requested web page. The web browser executes the received code to reproduce content of the requested web page and a widget script in the received code. Execution of the widget script comprises generating a container, which includes a list content area and an advertisement content area, rendering content in the list content area, and rendering content in the advertisement content area. The content in the widget and advertisement content areas is selected based on a relation to the content of the requested web page.

According to yet another embodiment a method involves requesting a web page and receiving web page code and widget code responsive to the request. The web page content is rendered using the web page code and a container is generated based on the widget code. A list is requested from an Application Programming Interface (API) being executed on a server, wherein the request includes an identification of the requested web page. The list is received from the API and an advertisement is also received from the API. The list concenter is rendered the generated container using the received list and rendering the advertisement in the generated container. The rendered list content and the advertisement are related to other content on the rendered web page.

Other embodiments of the invention are directed to systems and apparatus for performing these and other disclosed methods, as well as non-transitory computer-readable medium storing instructions, which when executed by a processor, cause the processor to perform one or more of the disclosed methods.

### BRIEF DESCRIPTION OF THE DRAWING FIGURES

FIG. 1 is a block diagram of an exemplary web page in accordance with the present invention;

FIGS. 2A-2F are block diagrams of exemplary web widgets in accordance with the present invention;

FIG. 3 is a block diagram of an exemplary system in accordance with the present invention;

FIG. 4 is a block diagram of an exemplary method for executing a browser plug-in in accordance with the present invention;

FIG. 5 is a block diagram of an exemplary computer in accordance with the present invention;

FIG. 6 is a block diagram of an exemplary list and/or advertisement server in accordance with the present invention;

FIG. 7 is a flow diagram of an exemplary method for providing widget content, including a list and an advertisement in accordance with the present invention;

FIG. 8 is a flow diagram of an exemplary method for generating and providing a list relevant to content of a web page in accordance with the present invention;

FIGS. 9A and 9B are flow diagrams of an exemplary method for a data collector in accordance with the present invention;

FIG. 10 is a flow diagram of an exemplary method for a keyword parser in accordance with the present invention;

FIG. 11 is a flow diagram of an exemplary method for a list generator in accordance with the present invention;

FIG. 12 is a flow diagram of an exemplary method for a web widget in accordance with the present invention;

FIG. 13 is a flow diagram of an exemplary method for a list refresher in accordance with the present invention;

FIG. 14 is a flow diagram of an exemplary method for a performance analyzer in accordance with the present invention; and

FIG. 15 is a flow diagram of an exemplary method for generating and delivering advertisements in accordance with the present invention.

### DETAILED DESCRIPTION

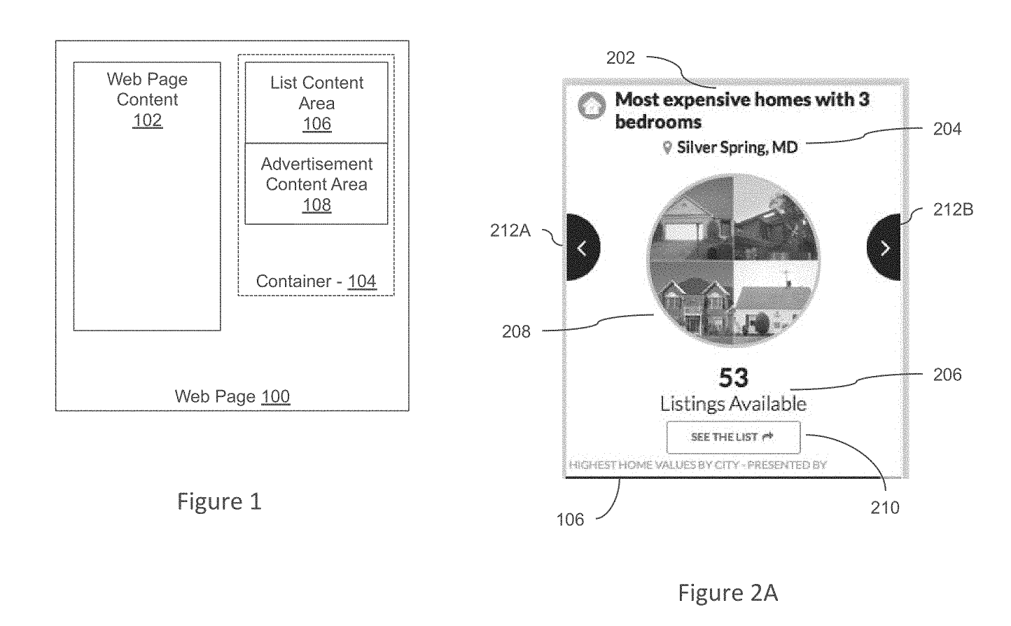

Exemplary embodiments are directed to systems and methods for delivering content and/or advertisements relevant to other content on a web page. Specifically, referring to FIG. 1, a web page 100 has a content section 102, which can include, among other things, news articles or other information. According to the present invention, a web widget generates a container 104, which includes a list content display area 106 and advertisement content display area 108, which respectively include information relevant to content 102 of web page 100. As will be described in more detail below, list content display area 106 displays lists of information relevant to content 102 and advertisement content display area 108 displays advertisements relevant to the content 102.

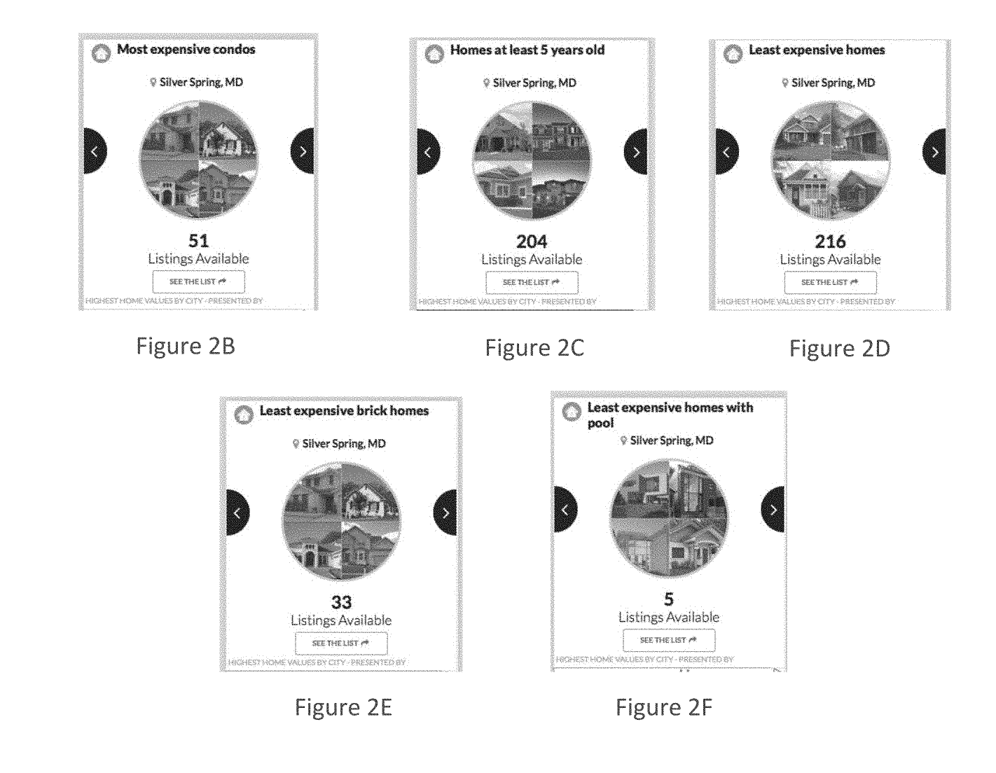

Examples of list content that can be displayed in list content display area 106 are illustrated in FIGS. 2A-2F, which are different lists related to real estate listings. For purposes of clarity only FIG. 2A includes reference numbers, however these reference numbers are equally applicable to corresponding portions of the list content display area 106 in FIGS. 2B-2F. The list content display area 106 includes a title portion 202 with text and/or graphics conveying the topic of the list, which in the illustrated example is a list of “Most expensive homes with 3 bedrooms.” The list content display area 106 also includes a subtitle portion 204 with text and/or graphics conveying information about the constraints of the list, which in the illustrated example are the geographic location of the real estate (Silver Spring, Md. in the example). Item count portion 206 includes text and/or graphics with the number of items in the list (53 in the illustrated example). Portion 208 includes a graphic relevant to the particular list, which in the illustrated example is a picture of real estate. The list content display area 106 also includes navigation controls 210, 212A, and 212B. Navigation control 210 is a link to a web page containing all of the items in the list, which in the illustrated example would be a web page listing 53 of the most expensive homes with 3 bedrooms in Silver Spring, Md. Navigation controls 212A and 212B are used to navigate between different lists in a “forward” and “backward” manner similar to forward and back controls of a browser, so that the list topic illustrated in FIG. 2A can be replaced by one of the list topics illustrated in FIGS. 2B-2F.

FIGS. 2B-2F illustrate list topics for real estate in Silver Spring, Md. In FIG. 2B the topic is the most expensive condos, in FIG. 2C the topic is homes that are at least 5 years old, in FIG. 2D the topic is the least expensive homes, in FIG. 2E the topic is least expensive brick homes, and in FIG. 2F the list topic is least expensive homes with a pool.

It should be recognized that the arrangement elements in list content display area 106, as well as types of elements included in this area, illustrated in FIGS. 2A-2F are merely examples and are not intended to be limiting. Accordingly, the navigation controls 210, 212A, and 212B, and portions 202, 204, 206, and 208 can be reproduced in different forms and/or in different locations than what is illustrated. Other non-limiting examples of content reproduced in list content display area 106 include statistics for athletes or sports teams (e.g., the top rebounders in the National Basketball Association or the team with the most extra points in the National Football League, etc.), information about investments (e.g., the stocks with the highest price-to-earnings ratio, highest trading volume, etc.), information about voting (e.g., the number of registered Republicans or Democrats in a particular area, the number of votes for a political candidate for a particular area, etc.), and the like. Thus, as will be appreciated, the illustrated list topics are merely non-limiting examples and the content can cover any type of information that can be conveyed in a list format.

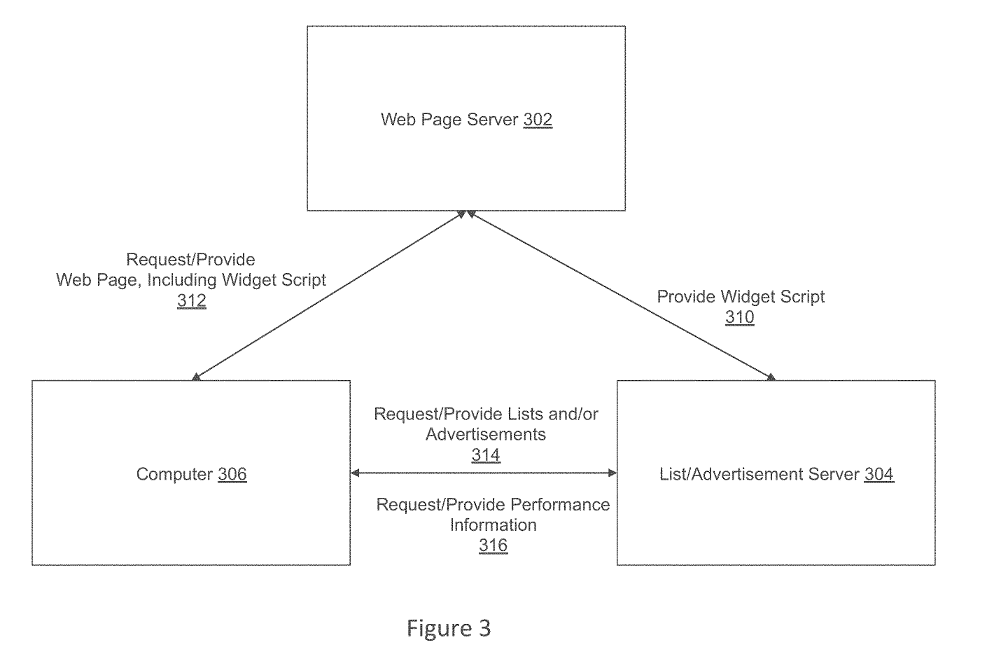

FIG. 3 is a block diagram of an exemplary system in accordance with the present invention. The system includes a web page server 302, which communicates with a list and/or advertisement server 304 and computer 306. As detailed below, list/advertisement server 304 provides a widget script to server 302 (step 310) so that the widget script is included on one or more web pages provided by web page server 302. Accordingly, when computer 306 requests a web page from web page server 302, the provided web page includes the widget script (step 312). The widget script then requests lists and/or advertisements from advertisement server 304, which provides the lists and/or advertisements (step 314), which are then reproduced by computer 306 on the web page.

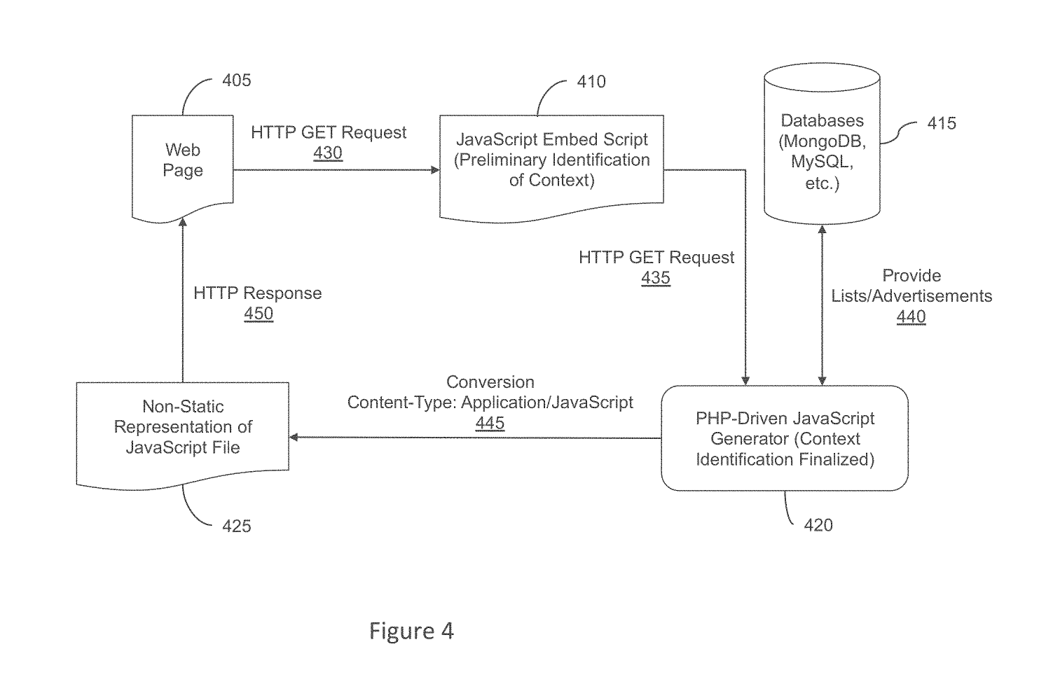

An example of this process when the widget is executed by a plug-in is illustrated in FIG. 4. Specifically, the web page 405 issues an HTTP GET Request to the JavaScript embedded script 410 (step 430), which in turn issues the HTTP GET Request to PHP-Driven JavaScript Generator 420 (step 435). PHP-Driven JavaScript Generator 420 also requests lists/advertisements from and is provided lists/advertisements by one or more list/advertisement servers/databases 415 (step 440). As noted in the figure, JavaScript Embed Script 410 generates a preliminary identification of context and PHP-Driven JavaScript Generator finalizes the context identification. In response to the HTTP Get Request from JavaScript Embed Script 410, PHP-Driven JavaScript Generator issues a conversion command to generate a Non-Static Representation of the JavaScript File 425 (step 445), which representation issues the HTTP Response to the web page 405 (step 450), thus providing the widget with the lists and/or advertisements that are to be reproduced on the web page. It will be recognized that similar steps are performed when the widget is executed as part of native browser code.

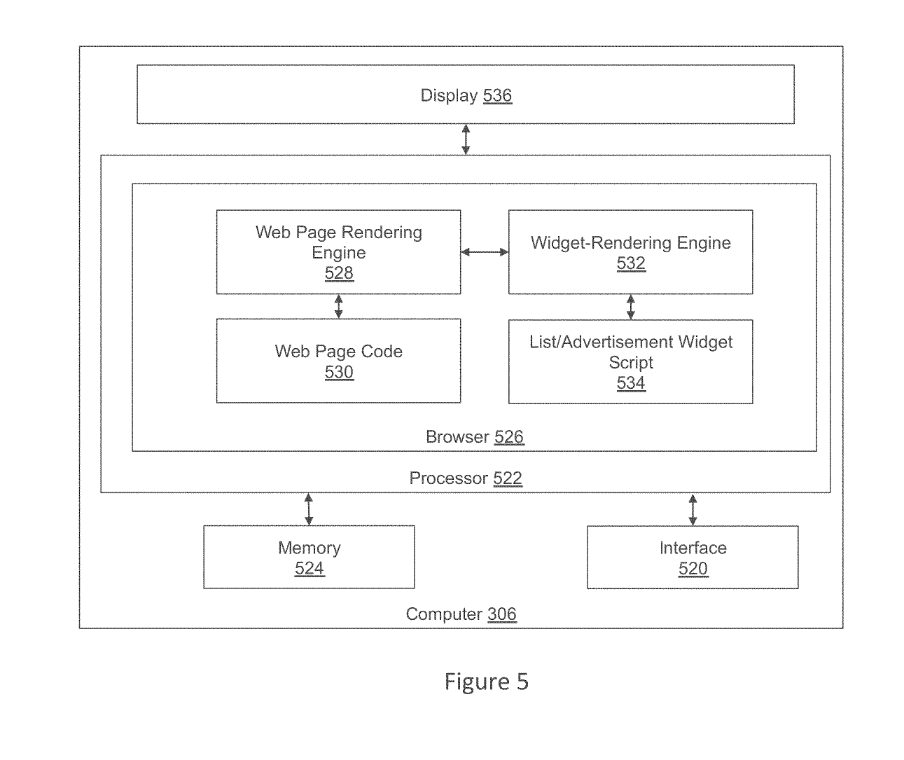

FIG. 5 is a block diagram of an exemplary computer 306 in accordance with the present invention. The present invention can be implemented on any type of device that is capable of reproducing web pages, and thus the term computer should be understood as including any device having such a capability, including desktop computers, laptop computers, smart phones, tablets, wearable computers, smart watches, and the like. Computer 306 includes one or more interfaces 520 for communicating with web page server 302 and/or list/advertisement server 304, which can be any type of wireless and/or wired interface. Interface 520 is coupled to processor 522, which is coupled to one or more memories 524 in order to execute applications and render/reproduce web pages. Processor 522 can be any type of processor, including a microprocessor, field programmable gate array (FPGA), application specific integrated circuit (ASIC), and/or the like. Memory 524 can include any type of memory, including random access memory (RAM), read-only memory (ROM), a solid state hard drive (SSD), a spinning hard drive, and/or the like. Further, some of the memory 524 can be external to the computer 306.

Using computer code loaded from memory 524, processor 522 executes a browser 526. Specifically, browser 526 includes a web page rendering engine 528, which executes web page code 530, typically in the form of HTML, obtained from a web page server. Browser 526 may also include one or more widget-rendering engines 532, which can execute a widget content and/or advertisement script 534. When the widget is implemented using native browser code, such as HTML and/or CSS, widget-rendering engine 532 can be part of web page rendering engine 528 and list/advertisement widget script 534 can be part of web page code 530. When the widget is implemented using non-native code of the browser, such as by using a plug-in, list/advertisement widget script 534 can be in the plug-in native code and widget-rendering engine 532 can be a plug-in engine, such as Oracle's Java, Adobe's Flash, Apple's QuickTime player, and/or the like. Thus, processor 522, using browser 526, provides a rendered web page, including any rendered plug-ins, to display 536 as an output for a user. Although display 536 is illustrated as being part of computer 306, the display can be an external component, depending upon the type of computer.

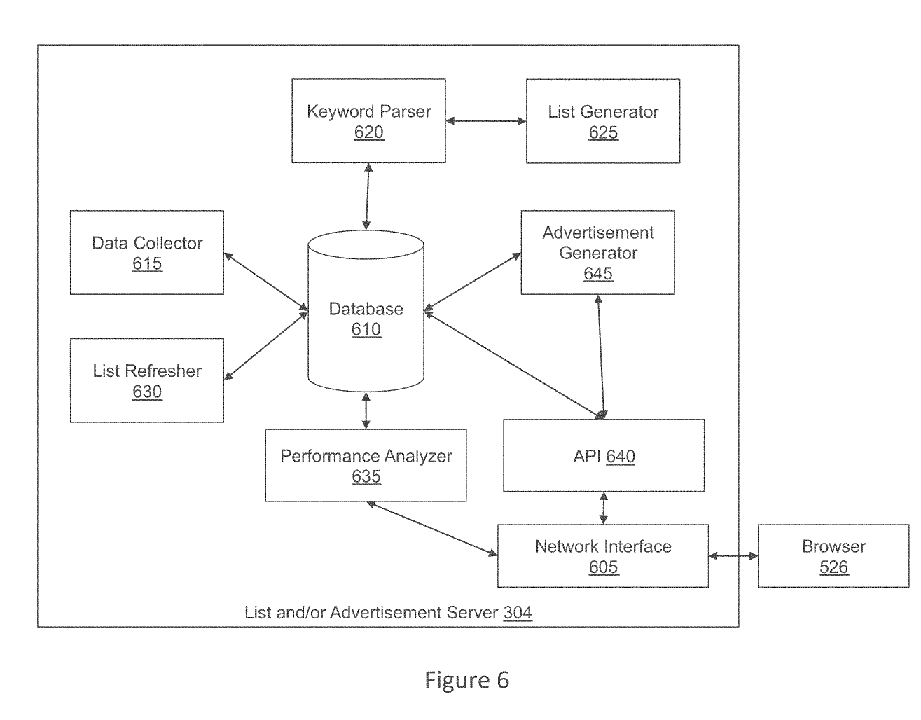

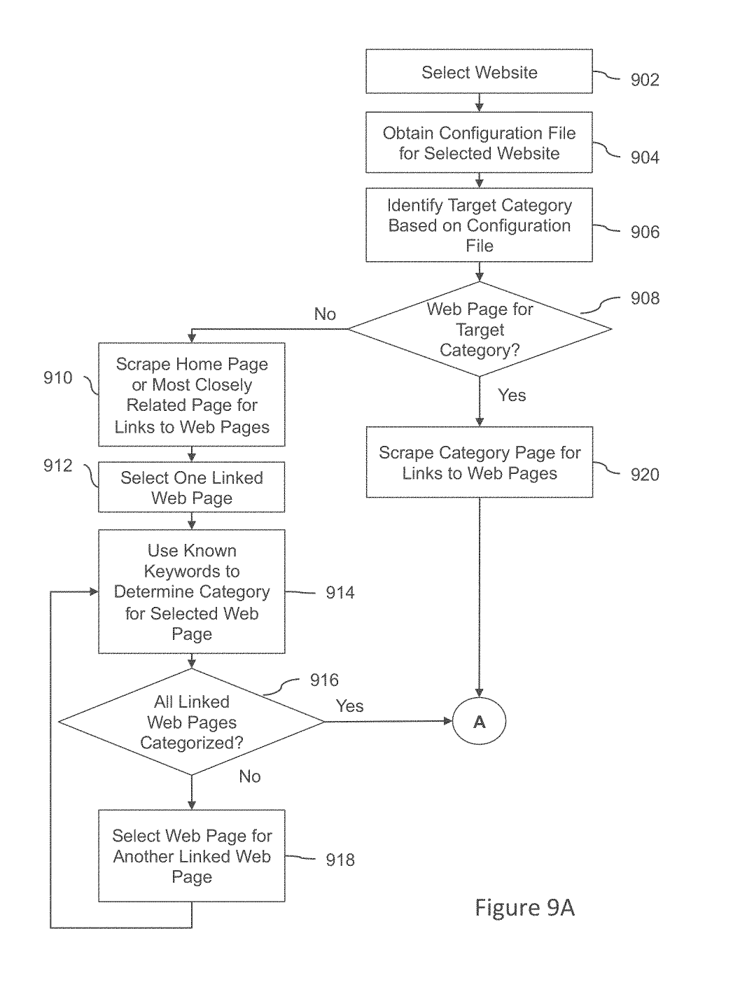

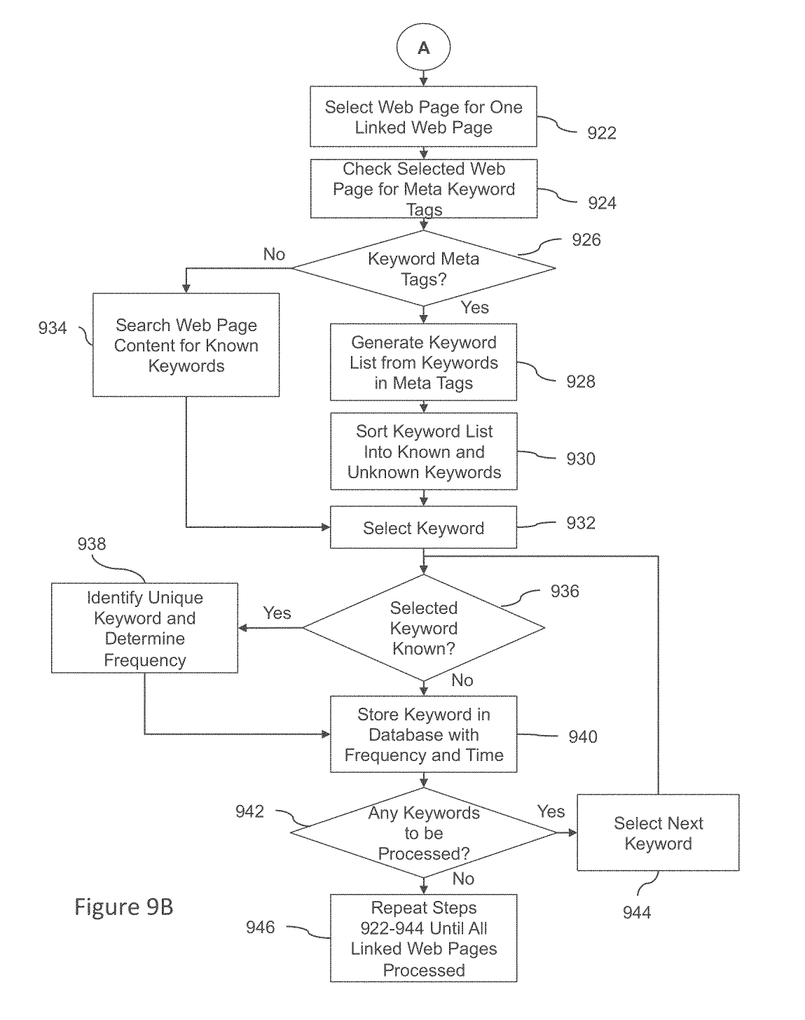

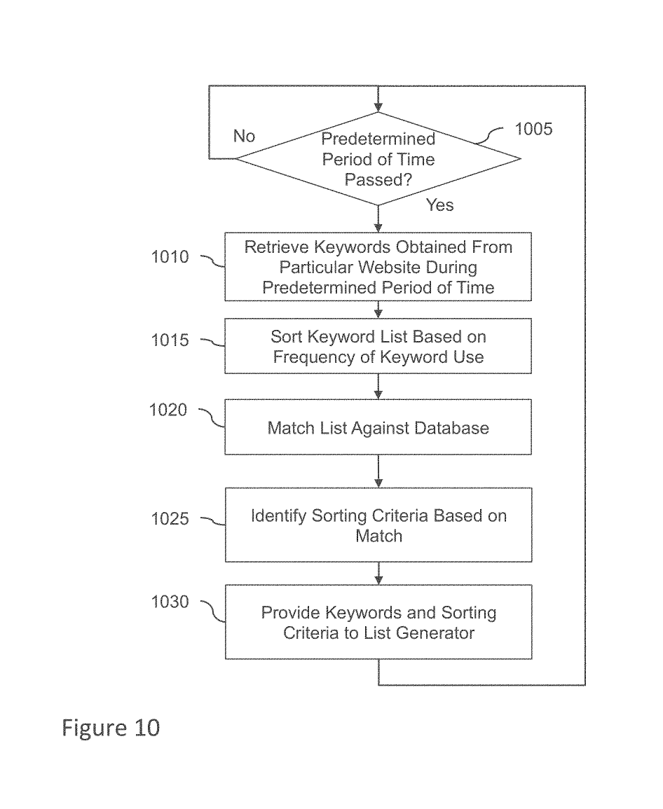

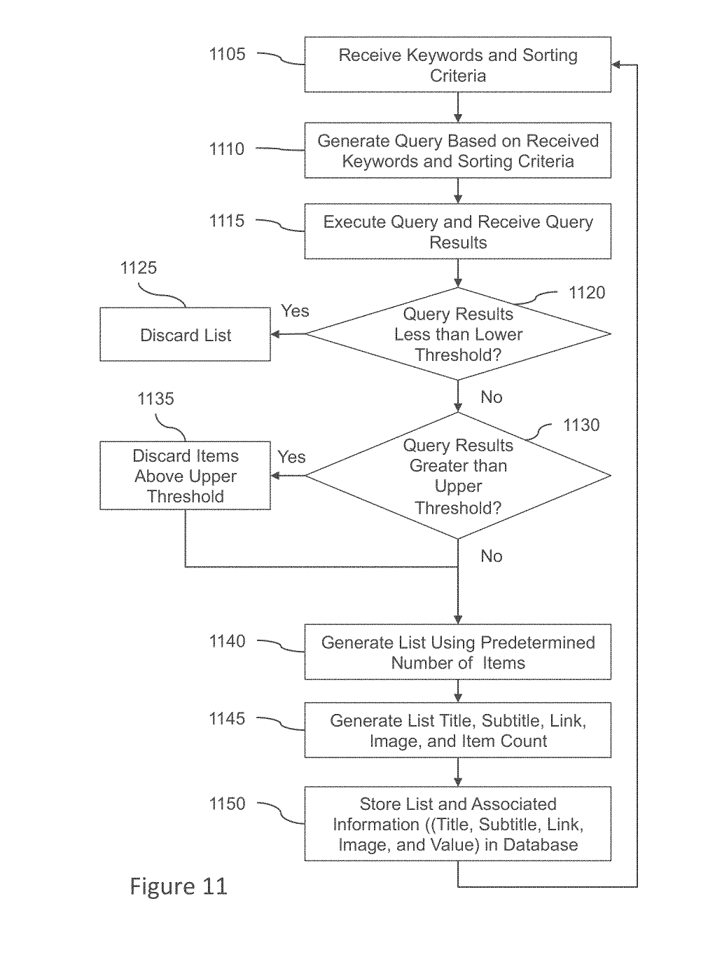

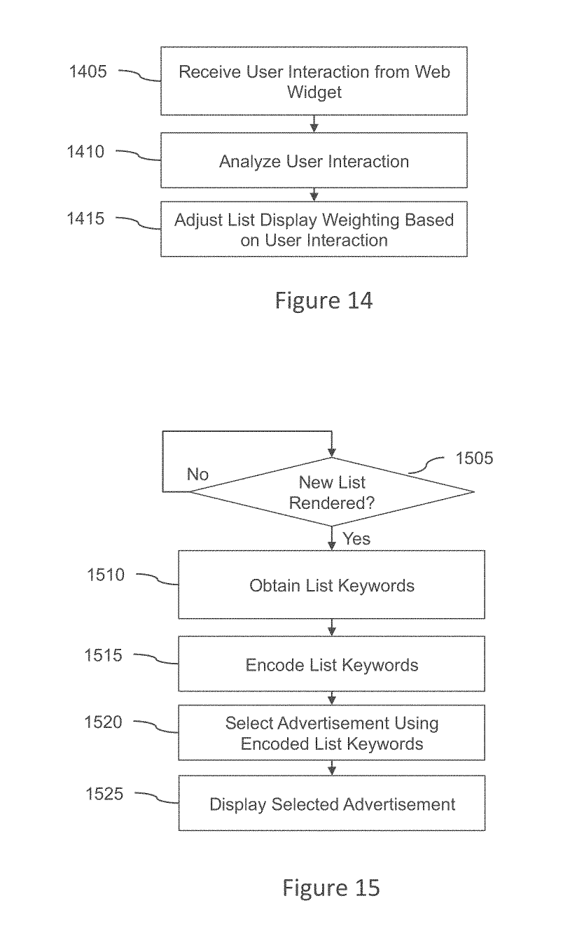

FIG. 6 is a block diagram of an exemplary list and/or advertisement server 304 in accordance with the present invention. Similar to computer 306, the server 306 includes, among other elements, a processor and memory, which have been omitted for sake of clarity. Apart from network interface 605 and database 610, remaining elements illustrated in the Figure are software components implemented on the processor of server 306 to execute the processes described in detail below in connection with the flow diagrams. These software components include a data collector 615 (described below in connection with FIGS. 9A and 9B), keyword parser 620 (described below in connection with FIG. 10), a list generator 625 (described below in connection with FIG. 11), list refresher 630 (described below in connection with FIG. 13), performance analyzer 635 (described below in connection with FIG. 14), application programming interface (API) 640, and advertisement generator 645 (described below in connection with FIG. 15).

Although details of the elements illustrated in FIG. 6 are described below, a brief overview of each element is provided to assist in the understanding of the overall operation of the system. Network interface 605 acts as an interface between server 304 and the Internet so that browser 526 can communicate with the various elements of server 304. Database 610 stores various types of data so that server 304 can provide list content and advertisement content relevant to other web page content to browser 526. Database 610 can be any type of database and can, depending upon implementation, comprise more than one database. Further, database 610 need not be an internal component of server 304 but instead can be externally coupled to server 304, including a local coupling or a coupling over the Internet to a remote site.

Data collector 615 evaluates one or more websites in order to identify keywords used in different sections of the websites, the keywords being used to identify list and advertisement content relevant to each of the different sections of the websites. Specifically, keywords are identified by the category of web page content for particular websites so that lists and/or advertisements relevant to the content of particular categories of web pages for particular web sites can be displayed in container 104. The data collected by data collector 615 is stored in database 610.

Keyword parser 620 retrieves the keywords stored by data collector 615 in database 610 in order to identify the frequency of use of one or more keywords and then identify and generate list sorting criteria and a list of keywords for use by list generator 625. List generator 625 generates lists of facts based on the keywords and sorting criteria and then stores the resulting lists in database 610. List refresher 630 periodically updates the facts in the various lists so that the facts are up-to-date. Performance analyzer 635 analyzes user interaction with the list and/or advertisement content, which can then be used to adjust the lists and/or advertisement content displayed to other users accessing web pages in the same category as the one the user accesses during the performance analysis.

API 640 provides the list and/or advertisement content to the browser plug-in for display in container 104. API 640 represents two primary API's—a website list API and list creation API. The website list API uses the website and category of the web page being accessed by the browser to select all the possible lists for that website and category. Information for one of the selected lists is then retrieved from database 610 and provided to widget-rendering engine 532 so that widget-rendering engine 532 can reproduce the information in list content area 106. The list for which information is provided can be selected randomly or based on a weighting assigned to the list by performance analyzer 635. The selected list can be provided in any format, such as JavaScript Object Notation (JSON) format. The list creation API is invoked when a user requests the entire list from the list content area 106, e.g., by actuating navigation element 210. The list creation API then provides the keyword, sorting criteria, and an input defining the list (e.g., most expensive homes with 3 bedrooms) to list generator 625, which then creates a list based on these three inputs and provides it back to API 640 to provide to the user's browser 526.

Advertisement generator 645 generates advertisements for display in advertisement content area 108 that are relevant to content 102 of the web page. This can be achieved a number of different ways, such as having advertisement generator 645 receive the keywords used to generate a list for list content area 106 or it can receive keywords for a particular website and web page category directly from database 610. The latter can be employed, for example, when the advertisement content is displayed separately from any type of list content.

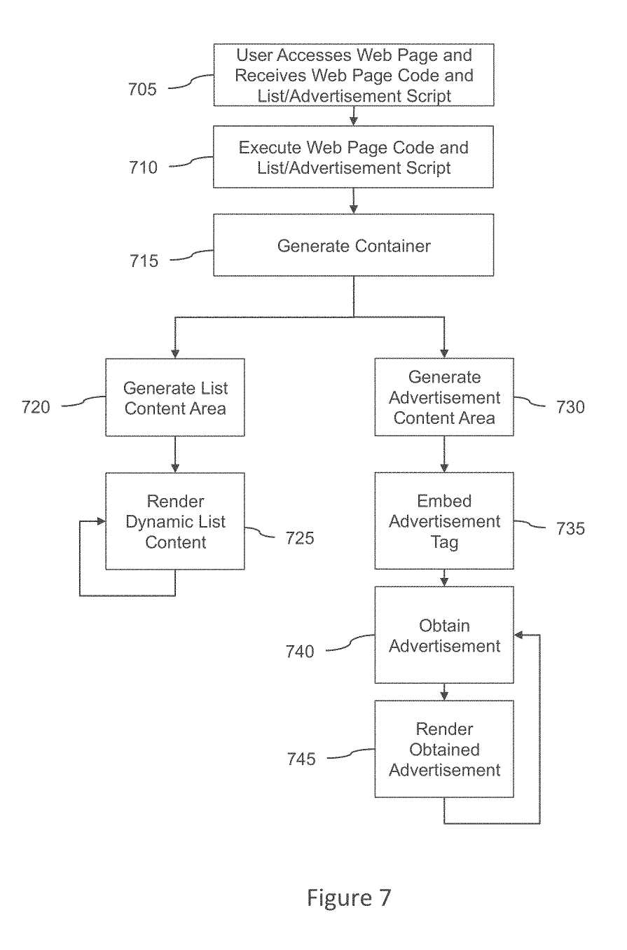

Now that the an overview of the system of the present invention has been provided, a description of the method of the present invention will be described in connection with FIGS. 7-15.

FIG. 7 is a flow diagram illustrating, at a high level, an exemplary method for providing widget content, including a list and an advertisement in accordance with the present invention. When a user of computer 306 accesses a web page browser 526 receives web page code 530 and list/advertisement widget script 534 from web page server 302 (step 705). Web page rendering engine 528 executes web page code 530 to reproduce content 102 and widget-rendering engine 532 executes list/advertisement widget script 534 to reproduce the list widget 106 and advertisement 108 (step 710). Specifically, widget-rendering engine 532 generates container 104 for the list widget 106 and advertisement 108 (step 715). Widget-rendering engine 532, executing list/advertisement widget script, then renders the content for the widget and advertisement content areas 106 and 108. Specifically, widget-rendering engine 532 generates list content area 106 (step 720) and then renders the dynamic list content in list content area 106 (step 725). As illustrated by the loop out of the rendering dynamic list content (step 725), the rendered content can change over time, such as in response to a user input on one of the navigation controls 208, 210A, and 210B. If the list content is already cached at the computer 306, the list content the Time to First Byte (TTFB) can be under 78 ms.

Widget-rendering engine 532 also generates the advertisement content area 108 (step 730), obtains an embedded advertisement tag (step 735), and uses the embedded advertisement tag to obtain an advertisement from list and/or advertisement server 304 (step 740). Widget-rendering engine 532 then renders the obtained advertisement (step 745). As illustrated by the loop out of the rendering obtained advertisement (step 745), the rendered advertisement content can change over time. For example, if, as described below in connection with FIG. 15, the advertisement is obtained from an advertisement network, the first displayed advertisement can be one that is locally cached so that it can be rendered quickly and then subsequent advertisements can be obtained from the advertisement network(s). Without using a locally cached advertisement as the first advertisement could cause the advertisement area to be blank due to the time it can take for an advertisement network to provide an advertisement based on keywords, which typically can take approximately 15 seconds. In addition or alternatively, the advertisement can change according to any criteria, such as passage of a predetermined amount of time. Of course, if desired, the rendered advertisement content can be statically displayed over time. It should be recognized that if the widget executes native browser code then the execution of the list/advertisement script could be performed by web page rendering engine 528 instead of widget-rendering engine 532.

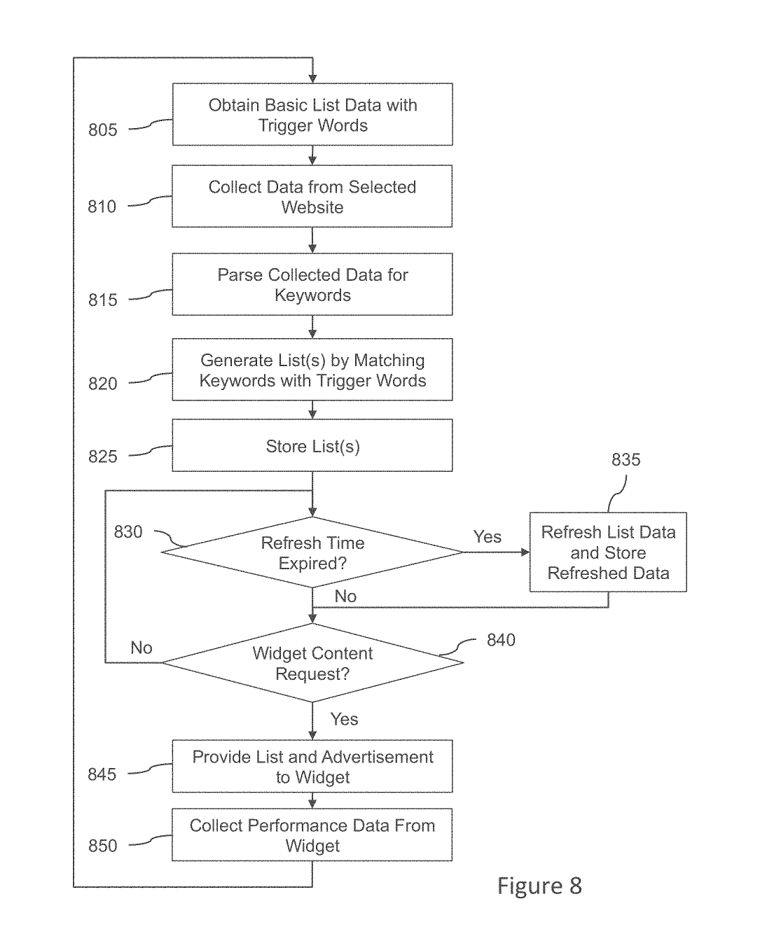

FIG. 8 is a flow diagram of an exemplary method for generating and providing a list relevant to content of a web page in accordance with the present invention. Initially, data collector 615 obtains a basic list of data along with trigger words (step 805). The basic list of data can be embodied in any form, such as a database having rows for each basic fact (e.g., the name of an athlete) and columns having information about the basic fact in the rows (e.g., different statistics for the athletes). The basic list of data can cover a wide variety of different types of information, such as a set of rows and columns for athletes of different sports, voting information for different geographic areas, real estate information, etc. The basic list of data can include both nationally relevant data (e.g., data related to a presidential election), as well as hyper-local data (e.g., data related to state, county, and/or city elections). One or more trigger words are associated with each of the different types of information so that list content 106 relevant to the web page content 102 can be displayed. Specifically, as discussed below, the trigger words are matched with keywords of different web page categories to identify lists/advertisements relevant to web pages in particular categories.

Data collector 615 then collects data from a selected website having web pages on which list content area 106 and/or advertisement content area 108 will be displayed (step 810). The data is collected so that keywords can be obtained, which are then used to identify widget content relevant to the content 102 of a web page on the selected website. Specifically, keyword parser 620 parses the collected data for keywords (step 815) and list generator 625 generates one or more lists by matching the keywords with trigger words (step 820). Although there may be a one-to-one relationship between keywords and trigger words, in many instances there will be more than one keyword associated with a particular trigger word. List generator 625 then stores the generated list in database 610. List refresher 630 maintains a timer to decide whether it is time to refresh the data in one or more of the lists (step 830). The refresh time can vary depending upon the data in a particular list so that a list of stock data can be refreshed, for example, every 15 minutes while the stock markets are opened, whereas a list of facts relevant to a sport can be refreshed once a day. If the refresh time has expired (“Yes” path out of decision step 830), then list refresher 630 refreshes the list data and stores the refreshed data in the list in database 610 (step 835).

After the list data is refreshed (step 835) or when the refresh time has not expired (“No” path out of decision step 830), API 640 determines whether it has received a request for widget content from browser 526 via network interface 605 (step 840). If not (“No” path out of decision step 840), then the refresh timer is monitored again (step 830). If API 640 determines that a request has been received (“Yes” path out of decision step 840), then API 640 obtains a list and advertisement from database 610 and provides them to the widget-rendering engine 532 of browser 526. While the browser 526 displays the list, widget-rendering engine 532 monitors user interaction with the widget and/or advertisement and provides this performance data to performance analyzer 635 via network interface 605 (step 850).

It should be recognized that the flow diagram of FIG. 8 is intended to illustrate the overall operation of the generation, display, and maintenance of the list content according to the invention and in same instances steps may or may not be performed in the illustrated order. For example, the monitoring of the refresh time by list refresher 630 (step 830) can be performed independently of and parallel to the determination by API 640 of whether widget content has been requested (step 840). Similarly, although FIG. 8 illustrates a return loop from the collection of performance data (step 850) to the obtaining of the basic list data (805), these are separate and distinct operations and can be performed independently of each other. Obtaining the basic list data can be a one-time event or can occur on a regular basis. Similarly, once one or more lists have been created, steps 810-825 can be performed independently or and parallel with the refreshing of list data (step 830), the providing of list content (step 845), and the collection of performance data (step 850).

FIGS. 9A and 9B are flow diagrams of an exemplary method for a data collector in accordance with the present invention, which details the operations performed by data collector 615 in step 810 in FIG. 8. Initially, data collector 615 selects a website from which it will collect data on the content so that relevant lists can be identified (step 902). Data collector 615 then obtains a configuration file for the selected website (step 904) and identifies a target category based on the configuration file (step 906). The configuration file contains information about different content categories for particular websites, such as politics, sports, national news, local news, and the like for a new website. Thus, the configuration identifies a website and one or more categories for the identified website.

Data collector 615 determines whether there is a webpage for the identified target category (step 908). For example, some websites may have well-defined category pages having links to other web pages related to the category, whereas other websites may not (e.g., different types of news stories are all on the same web pages). If there is not a web page for the target category (“No” path out of decision step 908), then data collector 615 scrapes the website's home page or a web page that is most closely related to the target category for links to web pages (step 910). Data collector 615 then selects one of the linked web pages (step 912) and uses known keywords to determine a category for the selected, linked web page (step 914). The known keywords can be stored in database 610 and can be organized by different categories (e.g., known basketball keywords can include terms, such as, dribble, three-point shot, rebound, etc.). If the known keywords are generic to different categories (e.g., rebound can be related to basketball, hockey, or soccer), then more than one of the known keywords may be relied upon to determine the category. Alternatively, the known keywords can be selected so that they are specific to the particular category and not overlap with other categories, which in the example above would mean that rebound would not be used as a known keyword. Data collector 615 then iterates through each of the linked web pages (steps 916, 918, and 914) until all linked webpages are categorized (“Yes” path out of decision step 916).

If there is a web page for the target category (“Yes” path out of decision step 908), then data collector 615 scrapes the corresponding category page for links to one or more web pages containing content in the target category (step 920). After scraping the corresponding category page (step 920) or after all linked web pages are categorized (“Yes” path out of decision step 916), data collector 615 selects one of the linked web pages (step 922) and checks the selected web page for keyword meta tags (step 924), which those skilled in the art will recognize are identified in web page code by a specific HTML tag. If the selected web page contains keyword meta tags (“Yes” path out of decision step 926), then data collector 615 generates a keyword list from the keywords in the meta tags (step 928) and sorts the keyword list into known and unknown keywords (step 930). Known keywords are those that have been previously associated with one of the lists stored in database 610 and unknown keywords are those that have not.

If the selected web page does not have keyword meta tags (“No” path out of decision path 926), then data collector 615 searches the content of the selected web page for known keywords (step 934). The search can include all of the web page content or only a portion (e.g., the title and first paragraph of the web page content). After the content is searched for known keywords (step 934) or after the keyword list is sorted into known and unknown keywords (step 930), one of the keywords is selected (step 932) and data collector 615 determines whether the selected keyword is a known keyword (step 936). If the selected keyword is a known keyword then the keyword is identified and its frequency of occurrence is determined (step 938). The frequency of occurrence can be based on the frequency of occurrence on the selected web page (or portion of the selected web page) and/or based on the frequency of occurrence across all web pages of a particular category (or portions of all web pages of a particular category).

After the frequency of keyword occurrence is performed (step 938) or if the selected keyword is not a known keyword (“No” path out of decision step 936), the selected keyword is stored in database 610 along with the frequency of occurrence and time of occurrence (step 940). If the keyword is a known keyword and the frequency of occurrence is across web pages then this storage can be limited to updating the frequency of occurrence count and time of occurrence for the previously stored, known keyword. If there are remaining keywords to be processed (“Yes” path out of decision step 942), then the next keyword is selected (step 944) and processed (steps 936 or 938 and step 940). Once all keywords are processed (“No” path out of decision step 942), steps 922-944 are repeated until all linked web pages have been processed (step 946).

It should be recognized that if there are no keyword meta tags (“No” path out of decision step 926), then after the web page content is searched for known keyword (step 934), the known keywords can be processed in step 938 without having to determine whether the selected keyword is known (step 936).

The method illustrated in FIGS. 9A and 9B can be repeated for additional target categories identified in the configuration file until all categories identified in the configuration file have been processed. Accordingly, for each target category identified in the configuration file the database 610 will now include a list of keywords, the frequency of keyword occurrence, and time of occurrences and these keywords, which are relevant to the content of the web pages of the respective target categories. This information can be used to generate lists relevant to the content of the web pages of the respective target categories in the manner described below.

FIG. 10 is a flow diagram of an exemplary method for keyword parser 620 in accordance with the present invention. Keyword parser 620 processes keywords identified by data collector 615 in order to provide information to list generator 625 for generating the lists for list content area 106. Keyword parser 620 periodically processes the identified keywords. Accordingly, once a predetermined period of time has passed (“Yes” path out of decision step 1005), keyword parser 620 retrieves keywords obtained from a particular category for a particular website during a predetermined period of time (step 1010). Keyword parser 620 sorts the keyword list based on frequency of keyword use (step 1015) and then matches the sorted lists against trigger words in database 610 (step 1020) in order to identify list-sorting criteria (step 1025). Specifically, as discussed above, the trigger words are associated with different types of information in the basic list data (e.g., different statistics for athletes), and accordingly a match between a keyword and a trigger word identifies sorting criteria, which in the database example above would be a column of information (e.g., a particular statistic for athletes). Keyword parser 620 then provides the keywords and sorting criteria to list generator 625 (step 1030).

FIG. 11 is a flow diagram of an exemplary method for list generator 625 in accordance with the present invention. Initially, list generator 625 receives the keywords and sorting criteria from keyword parser 620 (step 1105) and then generates a query for database 610 based on the received keywords and sorting criteria (step 1110). List generator 625 executes the query on database 610 and receives query results (step 1115). List generator 625 then determines whether the query results are sufficient for creating an appropriate list. In this example, whether the query results are sufficient is based on the number of items in the query results. Accordingly, if the query results are less than a lower threshold (“Yes” path out of decision step 1120), then the list is discarded (step 1125). This may be performed so that lists that do not have enough individual items to be of interest are not rendered in the list content area 106. For example, the lower threshold can be 5 items.

If the query results are greater than the lower threshold (“Yes” path out of decision step 1120), list generator 625 then determines whether the query results are greater than an upper threshold (step 1130). If the query results are greater than the upper threshold (“Yes” path out of decision step 1130), then all items in the list above the upper threshold amount are discarded (step 1135). If the query results are less than the upper threshold (“No” path out of decision step 1130) or after discarding items above the threshold (step 1135), then list generator 625 generates a list using a predetermined number of the items (step 1140). The upper threshold and the selection of a predetermined number of items are designed to limit the number of items in the generated lists to a number that may be of most interest. Thus, for example, the upper threshold can be set to 50 items and the predetermined number of items can be ¼ of the number of items, rounded to the nearest five items. The use of upper and lower thresholds to control the number of items in a list and whether to use a list of items can be omitted, if desired.

List generator 625 then generates a list title 202, list subtitle 204, link to the entire list 210, a list image 208, and list item count 206 (step 1145) and stores the list along with this information in database 610 (step 1150). The generated list is stored along with an identification of a corresponding website on which it can appear and a category identifying the specific sections of the website on which it can appear. This association to the website and category can be performed by keyword parser 620. Accordingly, database 610 now includes at least one list and the associated information that can be reproduced in list content area 106 by widget-rendering engine 532.

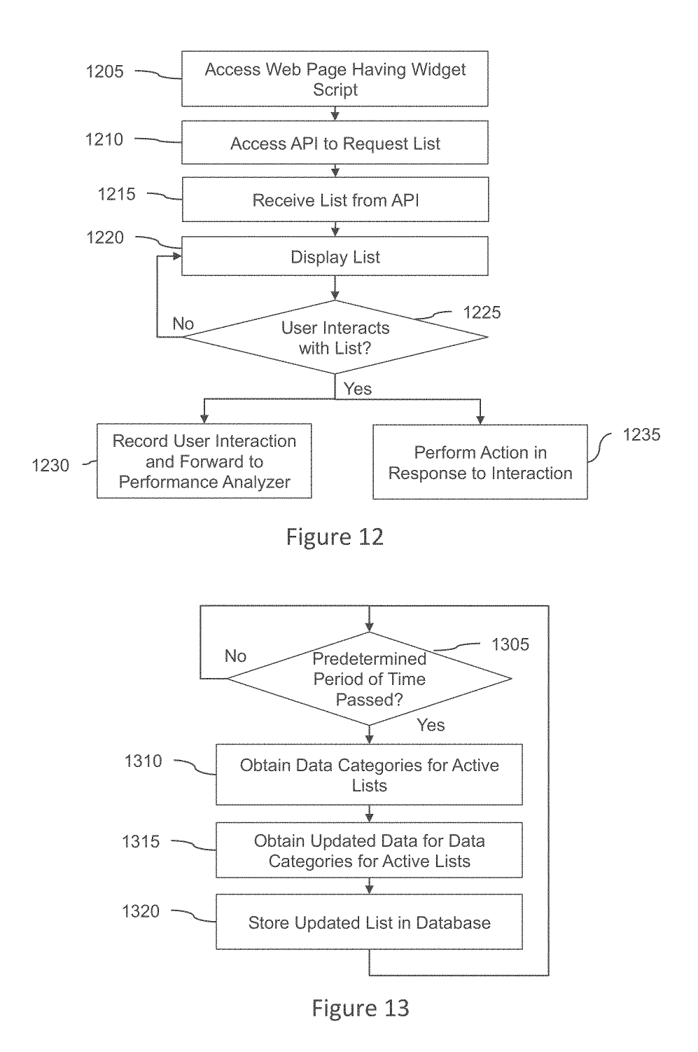

FIG. 12 is a flow diagram of an exemplary method for a web widget, which is executed by widget-rendering engine 532 in accordance with the present invention. When a browser 526 accesses a web page having a list/advertisement widget script 534 (step 1205), widget-rendering engine 532 executes the script to generate the web widget, which then accesses API 640 via network interface 605 to request a list from database 610 (step 1210). The web widget includes the category of the web page 100 on which it resides so that API 640 can select a list relevant to content 102 appearing on web pages in that category. Alternatively or additionally, the web widget can provide an identification of the current web page and API 640 can determine a corresponding category using a configuration file or other information stored in database 610. API 640 can select a list from a plurality of stored lists for the particular category for the particular website based on a weight assigned to the list by performance analyzer 635, which is described in more detail below in connection with FIG. 14. The web widget then receives the list from database 610 via API 640 and network interface 605 (step 1215) and displays it in list content area 106 (step 1220).

If the user interacts with the list while it is displayed (“Yes” path out of decision step 1225) the interaction is recorded and forwarded to performance analyzer 635 via network interface 605, which then stores the performance information in database 610 (step 1230). The web widget can also perform an action responsive to the user interaction (step 1235). For example, if the user selects one of the navigation controls 212A or 212B then another list is requested and then reproduced in list content area 106 and if the user selects navigation control 210 then a new web page is accessed that contains the entire list.

FIG. 13 is a flow diagram of an exemplary method for list refresher 630 in accordance with the present invention. When list refresher 630 determines a predetermined amount of time has passed (“Yes” path out of decision step 1305), it obtains data categories for all active lists (step 1310). List refresher 630 then obtains updated data for the data categories for the active lists (step 1315) and then stores the updated lists in database 610 (step 1320). Accordingly, when the web widget accesses a list from database 610 it will be up-to-date as of the last refresh time, which as discussed above can vary depending upon the type of facts in the list.

FIG. 14 is a flow diagram of an exemplary method for performance analyzer 635 in accordance with the present invention. When the performance analyzer 635 receives user interaction information from the web widget (step 1405), performance analyzer 635 analyzes the user interaction (step 1410) in order to adjust a display weighting for the list (step 1415). For example, if the user selects navigation controls 212A or 212B to select another list the performance analyzer can adjust the weighting of the list so that it is not displayed as often. On the other hand, if the user selects navigation control 210 to see the entire list then the performance analyzer can adjust the weighting of the list so that it is displayed more often. In addition to monitoring user clicks, the performance analyzer can also monitor other types of performance, such as a mouse hover over the list and/or advertisement content for a predetermined period of time (e.g., 1 second or more). Thus, a hover for a period equal to or greater than the predetermined period of time can indicate that the list and/or advertisement content is particularly interesting, and accordingly the associated weight can be adjusted to increase the likelihood of display for other users.

FIG. 15 is a flow diagram of an exemplary method for advertisement generator 645 to generate and deliver advertisements to advertisement content area 108 in accordance with the present invention. When advertisement generator 645 determines that a new list is rendered in list content area 106 (“Yes” path out of decision step 1505), it obtains the keywords used for generating the list content of list content area 106 (step 1510). Advertisement generator 645 then encodes the list keywords (step 1515) and provides the encoded list keywords to an advertisement network, which selects an advertisement (step 1520). It will be recognized that different advertisement networks require keywords be encoded in different formats, and thus the manner of encoding will depend upon which advertisement network is employed. For example, OpenX and Rubicon each require use of their own respective JavaScript method for keyword delivery and Criteo additionally requires the URL of the current web widget. The advertisement network then provides the selected advertisement to widget-rendering engine 532, which then displays the selected advertisement (step 1525).

If the new rendered list is the first list generated for the web page then, as described above, a cached advertisement can be the first displayed advertisement, which can then be replaced using an advertisement obtained from an advertisement network according to steps 1510-1525.

Although the method of FIG. 15 involves the advertisement generator 645 selecting advertisements using keywords obtained the list content of list content area 106, advertisement generator 645 can also be implemented to select keywords based on web page content 102. In this case advertisement generator can receive website and web page category information from the web widget and use that information to identify keywords that can be provided to the advertisement networks. This is particularly useful if the advertisement content area 108 is displayed without the list content area, and thus cannot obtain the keywords associated with the content in list content area 106.

Thus, it should be appreciated that the present invention can be implemented in various forms. The list content area 106 can be displayed alone in container 104 without advertisement content area 108, can be displayed along with advertisement content area 108, or advertisement content area 108 can be displayed alone in container 104 without list content area 106. These different forms can vary between different websites and even within different categories of a single website.

Although embodiments have been described above as involving the use of keywords collected from web pages to select list content, the present invention can be employed to select list content based on other factors, such as trending topics of the day. This may be useful for web pages containing content on trending news or breaking news where the content itself may not have a keyword corresponding to one of the trending topics of the day but would nonetheless be relevant as both the list content and the web page content would relate to information trends.

The techniques disclosed above can be embodied in a non-transitory computer readable medium, which when executed by a processor causes the processor to perform the disclosed techniques.

Although exemplary embodiments have been describe above in connection with the non-advertisement widget content being lists, the present invention is not limited in this manner. Instead, the collection of keywords from websites and the association of the keywords with particular categories of web pages can be used to select and display any type of content in the widget that is relevant to the main content of the web page.

The present invention improves the operation of a computer by reducing the processing burden and processing time for identifying and generating lists and/or advertisements relevant to other content on a web page. Further, the present invention is necessarily rooted in computer technology by solving problems unique to the Internet.

Although the present invention has been described above by means of embodiments with reference to the enclosed drawings, it is understood that various changes and developments can be implemented without leaving the scope of the present invention, as it is defined in the enclosed claims.

What is claimed is:

1. A method, comprising:
obtaining, by a computer, a configuration file for a selected website having a plurality of web pages;
selecting, by the computer, a web page from the plurality of web pages;
identifying, by the computer, links to at least two additional web pages on the selected web page;
analyzing, by the computer, content of the at least two additional web pages to identify one or more keywords;
sorting, by the computer, the one or more keywords based on frequency of use on the at least two additional web pages;
matching, by the computer, the one or more keywords with target words;
identifying, by the computer, one or more sorting criteria based on the match of the one or more keywords with the target words;
generating a plurality of lists based on the one or more keywords and the one or more sorting criteria;
generating, by the computer, code for a web browser to display a container including a list content area and an advertisement content area; and
providing the generated code to the web browser, wherein the list content area displays information for one of the plurality of lists and the advertisement content area displays an advertisement related to the one of the plurality of lists.

2. The method of claim 1, wherein the generation of the plurality of lists comprises:
generating, by the computer, a query based on the one or more keywords and the one or more sorting criteria;
sending the generated query to a database;
receiving query results from the database, wherein the query results include a plurality of individual pieces of information and at least one common aspect for each of the plurality of pieces of information; and
sorting the plurality of individual pieces of information according to one of the at least one common aspect.

3. The method of claim 2, wherein the selected website is a realty website, the plurality of individual pieces of information are real estate for sale or rent on the realty website, and the at least one common aspect is selected from the group comprising price, location, type of realty, exterior features of the real estate, or interior features of the real estate.

4. The method of claim 2, wherein the selected website is a news website, the plurality of web pages are different categories of news, and the at least two additional web pages contain articles in a common one of the different categories of news.

5. The method of claim 4, wherein the common one of the different categories of news is a particular sport, the plurality of individual pieces of information are players or teams of the particular sport, and the at least one common aspect is a statistic for the players or teams.

6. The method of claim 1, wherein the advertisement related to the one of the plurality of lists is selected by:
encoding, by the computer, the one or more keywords; and
selecting the advertisement based on the encoded one or more keywords.

7. The method of claim 6, wherein the selection of the advertisement is performed by a computer that is distinct from the computer that encoded the one or more keywords.

8. The method of claim 7, wherein the distinct computer provides the selected advertisement to the web browser.

9. A method, comprising:
receiving, by a web browser being executed on a processor, code corresponding to a requested web page;
executing, by the web browser, the received code to reproduce content of the requested web page;
executing, by the web browser, a widget script in the received code, wherein the execution of the widget script comprises
generating a container, which includes a list content area and an advertisement content area;
rendering content in the list content area; and
rendering content in the advertisement content area,
wherein the content in the widget and advertisement content areas is selected based on a relation to the content of the requested web page.

10. The method of claim 9, wherein the content of the requested web page is in a defined category of content and the content in the list content area is selected based on keywords assigned to the defined category of content.

11. The method of claim 10, wherein the content in the advertisement content area is selected based on keywords assigned to the content in the list content area.

12. A method for a web browser, the method comprising:
requesting a web page;
receiving, responsive to the request, web page code and widget code;
rendering the web page content using the web page code;
generating a container based on the widget code;
requesting a list from an Application Programming Interface (API) being executed on a server, wherein the request includes an identification of the requested web page;
receiving the list from the API and an advertisement; and
rendering list content in the generated container using the received list and rendering the advertisement in the generated container, wherein the rendered list content and the advertisement is related to other content on the rendered web page.

13. The method of claim 12, further comprising:
analyzing user interaction with the rendered list content or advertisement;
storing information regarding the user interaction; and
sending the stored information regarding user interaction to a server.

14. The method of claim 13, wherein the user interaction is a click on a navigation element of the rendered list content and the method further comprises one of:
rendering another list content in the generated container; or
rendering a complete list of items for the rendered list content.

15. The method of claim 12, wherein the rendered list content includes information regarding a content of a list of items but does not include individual items in the list received from the API.
